(19) United States
(12) Patent Application Publication
(10) Pub. No.: US 2017/0160300 A1
(43) Pub. Date: Jun. 8, 2017

(54) LATERAL FLOW / IMMUNO-CHROMATOGRAPHIC STRIP SERVICE AND CASSETTE ANALYSIS DEVICE SYSTEM, METHOD AND COMPUTER READABLE MEDIUM

(71) Applicant: FIO CORPORATION, TORONTO (CA)

(72) Inventor: JEFFREY CHANG, TORONTO (CA)

(21) Appl. No.: 15/325,244

(22) PCT Filed: Jul. 10, 2015
(86) PCT No.: PCT/CA15/00435

§ 371 Date: Jan. 10, 2017

Related U.S. Application Data
(60) Provisional application No. 62/022,959, filed on Jul. 10, 2014.

(51) Int. Cl. G01N 35/10; G01N 30/02

(52) U.S. Cl. CPC G01N 35/1095; G01N 30/02

(57) ABSTRACT

A novel system includes a service module which communicates with a client module and cassette-specific modules, and determines supported cassette types and configuration parameters for each. Algorithms of the cassette-specific modules use tool sets to identify, analyze and process cassettes of the supported cassette types. The service module receives results of the algorithms and communicates them to the client module. The system is certified for use with the cassette types. When a new cassette type is added, a new cassette-specific module is received, and the service module identifies the new cassette type as supported, determines its configuration parameters, and communicates with the new cassette-specific modules. Integrity of each of the old cassette-specific modules is preserved intact, such that the system remains certified for use with the old cassette types. A novel device, method and computer readable medium are also taught.

### FIELD OF THE INVENTION

The present invention relates generally to the field of lateral flow and/or immuno-chromatographic strip cassettes, and more particularly to a device, system, method and computer readable medium for service and analysis of such cassettes.

### BACKGROUND OF THE INVENTION

In the prior art and/or in view thereof, it may be desirable to provide a cassette analysis system structure and/or a cassette analysis device, system, method and/or computer readable medium. It may be desirable to provide a lateral flow/immuno-chromatographic strip (“ICS”) service and/or cassette analysis device, system, method and/or computer readable medium.

It may be desirable to provide a lateral flow/ICS service and/or cassette analysis device, system, method and/or computer readable medium which mitigates or reduces risk and/or certification overhead. It may be desirable to provide a lateral flow/ICS service and/or cassette analysis device, system, method and/or computer readable medium which may be extended without affecting existing certified functionalities and/or modules. For example, it may be desirable to provide such a device, system, method and/or computer readable medium which may be so extended by adding support of some cassettes, and/or by adding some new image processing functionalities.

It may be desirable to provide a lateral flow/ICS service and/or cassette analysis device, system, method and/or computer readable medium which may be configured remotely. It may be desirable to provide a lateral flow/ICS service and/or cassette analysis device, system, method and/or computer readable medium which is configurable:
To enable and/or disable one or more certain cassettes, for example, in response to a cassette recall issued by a cassette manufacturer, and/or in response to a customer's project requirement. And/or,
To afford one or more cassette-specific configurations, such as, for example, incubation timer value configurations, expiration timer value configurations, and/or even test line value cut-off value configurations.

It may be an object of the present invention to solve, obviate or mitigate one or more problems, disadvantages and/or shortcomings associated with the prior art, to meet or provide for one or more needs and/or advantages, and/or to achieve one or more objects of the invention—one or more of which may preferably be readily appreciable by and/or suggested to those skilled in the art in view of the teachings and/or disclosures hereof.

### SUMMARY OF THE INVENTION

According to the invention, there is disclosed a cassette analysis and service system used by a processing device. The cassette analysis and service system is for use with cassettes of a plurality of cassette types supported by the cassette analysis system. The cassette types include lateral flow and/or immuno-chromatographic strip types. The cassette analysis and service system is also for use with a client module running locally on the processing device and/or remotely over a network. The cassette analysis and service system includes a service module, one or more configuration components, a plurality of cassette-specific modules, and a plurality of tool sets. The service module is in communication with the client module. The configuration components includes one or more lists of the cassette types supported by the cassette analysis system and configuration parameters for each of the cassette types. The service module determines, from the configuration components, the cassette types supported by the cassette analysis and service system and the configuration parameters for each of the cassette types. Each of the cassette-specific modules includes one or more cassette-specific algorithms specifically adapted for identification, analysis and/or processing of a predetermined one of the cassette types. The service module communicates with each of the cassette-specific modules using one or more sets of pre-defined generic interfaces. Each of the tool sets includes a set of one or more tools adapted for identification, analysis and/or processing of the cassette types. Each of the cassette-specific algorithms is specifically adapted to use a predetermined one or more of the tool sets in identifying, analyzing and/or processing the predetermined one of the cassette types. In use: the client module communicates with the service module; the service module communicates with the cassette-specific modules; the cassette-specific algorithms of the cassette-specific modules use the tool sets to identify, analyze and/or process the cassettes of the cassette types supported by the cassette analysis and service system; the cassette-specific modules communicate results of the cassette-specific algorithms to the service module; and the service module communicates the results to the client module; such that the processing device identifies, analyzes and/or processes the cassettes of the cassette types supported by the cassette analysis and service system. The cassette analysis and service system is certified for use with at least one of the cassette types. When a new cassette type is added to the cassette types supported by the cassette analysis and service system: a new one of the cassette-specific modules and a new one of the configuration components are received by the processing device; the service module determines, from the new one of the configuration components, the new cassette type as supported by the cassette analysis and service system and the configuration parameters for the new cassette type; the service module communicates with the new one of the cassette-specific modules using said one or more sets of the pre-defined generic interfaces; and according to the invention, an integrity of each other one of the cassette-specific modules is preserved intact, such that the cassette analysis and service system remains certified for use with the aforesaid at least one of the cassette types.

According to an aspect of one preferred embodiment of the invention, the cassette analysis and service system may preferably, but need not necessarily, be adapted for use with images of the cassettes. In use, the cassette-specific algorithms of the cassette-specific modules may preferably, but need not necessarily, use the tool sets to identify, analyze and/or process the images of the cassettes of the cassette types supported by the cassette analysis and service system.

According to an aspect of one preferred embodiment of the invention, the service module may preferably, but need not necessarily, take requests from the client module and/or control an analysis process in different modes, preferably according to the requests from the client module.

According to an aspect of one preferred embodiment of the invention, the configuration components may preferably, but need not necessarily, include configuration data, preferably formatted in one or more Extensible Markup Language (“XML”) file formats and/or Javascript Object Notation (“JSON”) file formats.

According to an aspect of one preferred embodiment of the invention, the service module may preferably, but need not necessarily, parse the configuration data preferably to determine the cassette types supported by the cassette analysis and service system and/or the configuration parameters for each of the cassette types.

According to an aspect of one preferred embodiment of the invention, the configuration parameters may preferably, but need not necessarily, include incubation timer value configuration parameters, expiration timer value configuration parameters, and/or test line value cut-off value configuration parameters, preferably for one or more of the cassette types.

According to an aspect of one preferred embodiment of the invention, the cassette-specific algorithms may preferably, but need not necessarily, be specifically adapted for identification, analysis and/or processing using one or more incubation timer value configurations, expiration timer value configurations, and/or test line value cut-off value configurations.

According to an aspect of one preferred embodiment of the invention, the cassette-specific modules may preferably, but need not necessarily, include un-configurable parameters and/or templates specifically adapted for identification, analysis and/or processing of the predetermined one of the cassette types.

According to an aspect of one preferred embodiment of the invention, the cassette-specific algorithms of each of the cassette-specific modules may preferably, but need not necessarily, be specifically adapted for identification, analysis and/or processing of a membrane location, a control line, and/or a test line of the predetermined one of the cassette types.

According to an aspect of one preferred embodiment of the invention, the sets of pre-defined generic interfaces may preferably, but need not necessarily, include: an identity interface preferably for communicating an identity of the predetermined one of the cassette types; one or more label interfaces preferably for communicating when the predetermined one of the cassette types may be labeled and/or when a label may be matched on the predetermined one of the cassette types; and/or one or more analysis and/or interpretation interfaces.

According to an aspect of one preferred embodiment of the invention, each of the cassette-specific algorithms may preferably, but need not necessarily, employ a call sequence preferably to make use of the predetermined one or more of the tool sets.

According to an aspect of one preferred embodiment of the invention, the tools may preferably, but need not necessarily, be used to identify the cassettes, to check labeling on the cassettes, and/or to analyze the cassettes.

According to an aspect of one preferred embodiment of the invention, the cassette analysis and service system may preferably, but need not necessarily, also include a tool box module. The tool box module may preferably, but need not necessarily, include one or more collections of the tool sets. The tool box module may preferably, but need not necessarily, construct the predetermined one or more of the tool sets, preferably when called for by the cassette-specific algorithms.

According to an aspect of one preferred embodiment of the invention, preferably when a new tool may be added to the tools adapted for identification, analysis and/or processing of the cassettes: a new one of the cassette-specific modules and/or a new one of the tool sets including the new tool may preferably, but need not necessarily, be received by the processing device; the cassette-specific algorithms of the new one of the cassette-specific modules may preferably, but need not necessarily, be specifically adapted to use the new one of the tool sets preferably in identifying, analyzing and/or processing the predetermined one of the cassette types; and the integrity of the aforesaid each other one of the cassette-specific modules may preferably be preserved intact, preferably such that the cassette analysis and service system may preferably, but need not necessarily, remain certified for use with the aforesaid at least one of the cassette types.

According to an aspect of one preferred embodiment of the invention, preferably when an unsupported cassette type may be removed from the lists of the cassette types supported by the cassette analysis and service system: the service module may preferably, but need not necessarily, determine from the configuration components that the unsupported cassette type may be absent from the lists of the cassette types supported by the cassette analysis and service system; and the integrity of each of the cassette-specific modules may preferably be preserved intact, preferably such that the cassette analysis and service system may preferably, but need not necessarily, remain certified for use with the aforesaid at least one of the cassette types.

According to the invention, there is also disclosed a cassette analysis and service device for use with cassettes of a plurality of supported cassette types. The cassette types include lateral flow and/or immuno-chromatographic strip types. The cassette analysis and service device is also for use with a client module running locally on the cassette analysis and service device and/or remotely over a network. The cassette analysis and service device includes a service module, one or more configuration components, a plurality of cassette-specific modules, and a plurality of tool sets. The service module is in communication with the client module. The configuration components include one or more lists of the supported cassette types and configuration parameters for each of the supported cassette types. The service module determines, from the configuration components, the supported cassette types and the configuration parameters for each of the supported cassette types. Each of the cassette-specific modules includes one or more cassette-specific algorithms specifically adapted for identification, analysis and/or processing of a predetermined one of the supported cassette types. The service module communicates with each of the cassette-specific modules using one or more sets of pre-defined generic interfaces. Each of the tool sets includes a set of one or more tools adapted for identification, analysis and/or processing of the supported cassette types. Each of the cassette-specific algorithms is specifically adapted to use a predetermined one or more of the tool sets in identifying, analyzing and/or processing the predetermined one of the supported cassette types. In use: the client module communicates with the service module; the service module communicates with the cassette-specific modules; the cassette-specific algorithms of the cassette-specific modules use the tool sets to identify, analyze and/or process the cassettes of the supported cassette types; the cassette-specific modules communicate results of the cassette-specific algorithms to the service module; and the service module communicates the results to the client module; such that the cassette analysis and service device identifies, analyzes and/or processes the cassettes of the supported cassette types. The cassette analysis and service device is certified for use with at least one of the supported cassette types. When a new cassette type is added to the supported cassette types: a new one of the cassette-specific modules and a new one of the configuration components are received by the cassette analysis and service device; the service module determines, from the new one of the configuration components, the new cassette type as one of the supported cassette types and the configuration parameters for the new cassette type; the service module communicates with the new one of the cassette-specific modules using the aforesaid one or more sets of the pre-defined generic interfaces; and an integrity of each other one of the cassette-specific modules is preserved intact, such that the cassette analysis and service device remains certified for use with the aforesaid at least one of the supported cassette types.

According to the invention, there is also disclosed a cassette analysis and service method for use with cassettes of a plurality of cassette types supported by the cassette analysis and service method. The cassette types include lateral flow and/or immuno-chromatographic strip types. The cassette analysis and service method includes steps (a) through (d). In step (a), a service module communicates with a client module running locally and/or remotely over a network. In step (b), the service module determines, from one or more configuration components, the cassette types supported by the cassette analysis and service method and the configuration parameters for each of the cassette types. In step (c), the service module uses one or more sets of pre-defined generic interfaces to communicate with cassette-specific modules. Each of the cassette-specific modules includes one or more cassette-specific algorithms specifically adapted for identification, analysis and/or processing of a predetermined one of the cassette types. In step (d), each of the cassette-specific algorithms uses a predetermined one or more tool sets. Each of the tool sets includes a set of one or more tools. In step (d), the predetermined one or more tool sets are used in identifying, analyzing and/or processing the predetermined one of the cassette types. In step (d), the cassette-specific algorithms of the cassette-specific modules use the tool sets to identify, analyze and/or process the cassettes of the cassette types supported by the cassette analysis and service method. In step (c), the cassette-specific modules communicate results of the cassette-specific algorithms to the service module. In step (a), the service module communicates the results to the client module. As such, the cassette analysis and service method identifies, analyzes and/or processes the cassettes of the cassette types supported by the cassette analysis and service method. The cassette analysis and service method is certified for use with at least one of the cassette types. When a new cassette type is added to the cassette types supported by the cassette analysis and service system, the cassette analysis and service method also includes steps (e) through (g). In step (e), a new one of the cassette-specific modules and a new one of the configuration components are received. In step (f), the service module determines, from the new one of the configuration components, the new cassette type as supported by the cassette analysis and service system and the configuration parameters for the new cassette type. In step (g), the service module communicates with the new one of the cassette-specific modules using the aforesaid one or more sets of the pre-defined generic interfaces. According to the invention, steps (e) through (g) are all such that an integrity of each other one of the cassette-specific modules is preserved intact, and such that the cassette analysis and service method remains certified for use with the aforesaid at least one of the cassette types.

According to an aspect of one preferred embodiment of the invention, the cassette analysis and service method may preferably, but need not necessarily, be adapted for use with images of the cassettes. Preferably in step (d), the cassette-specific algorithms of the cassette-specific modules may preferably, but need not necessarily, use the tool sets to identify, analyze and/or process the images of the cassettes of the cassette types supported by the cassette analysis and service system.

According to an aspect of one preferred embodiment of the invention, preferably in step (a), the service module may preferably, but need not necessarily, take requests from the client module. The service module may preferably, but need not necessarily, control an analysis process in different modes, preferably according to the requests from the client module.

According to an aspect of one preferred embodiment of the invention, the configuration components may preferably, but need not necessarily, include configuration data. Preferably in step (b), the service module may preferably, but need not necessarily, parses the configuration data preferably to determine the cassette types supported by the cassette analysis and service method and/or the configuration parameters for each of the cassette types.

According to an aspect of one preferred embodiment of the invention, preferably in step (d), the cassette-specific algorithms may preferably, but need not necessarily, identify, analyze and/or process the predetermined one of the cassette types preferably using one or more incubation timer value configurations, expiration timer value configurations, and/or test line value cut-off value configurations.

According to an aspect of one preferred embodiment of the invention, preferably in step (d), the cassette-specific algorithms of each of the cassette-specific modules may preferably, but need not necessarily, identify, analyze and/or process a membrane location, a control line, and/or a test line of the predetermined one of the cassette types.

According to an aspect of one preferred embodiment of the invention, preferably in step (c), the sets of pre-defined generic interfaces may preferably, but need not necessarily, include: an identity interface preferably for communicating an identity of the predetermined one of the cassette types; one or more label interfaces preferably for communicating when the predetermined one of the cassette types may be labeled and/or when a label may be matched on the predetermined one of the cassette types; and/or one or more analysis and/or interpretation interfaces.

According to an aspect of one preferred embodiment of the invention, preferably in step (d), each of the cassette-specific algorithms may preferably, but need not necessarily, employ a call sequence to make use of the predetermined one or more tool sets.

According to an aspect of one preferred embodiment of the invention, preferably in step (d), the tools may preferably, but need not necessarily, be used to identify the cassettes, to check labeling on the cassettes, and/or to analyze the cassettes.

According to an aspect of one preferred embodiment of the invention, the cassette analysis and service method may preferably, but need not necessarily, also include step (h) of using a tool box module, which may preferably include one or more collections of the tool sets, preferably to construct the predetermined one or more tool sets preferably when called for by the cassette-specific algorithms.

According to an aspect of one preferred embodiment of the invention, preferably when a new tool may be added to the tools which may preferably, but need not necessarily, be adapted for identification, analysis and/or processing of the cassettes, the cassette analysis and service method may preferably, but need not necessarily, also include steps (h) and (i). Preferably in step (h), a new one of the cassette-specific modules and/or a new one of the tool sets including the new tool may preferably, but need not necessarily, be received. Preferably in step (i), the cassette-specific algorithms of the new one of the cassette-specific modules may preferably, but need not necessarily, use the new one of the tool sets in identifying, analyzing and/or processing the predetermined one of the cassette types. Steps (h) and (i) may preferably, but need not necessarily, be such that the integrity of the aforesaid each other one of the cassette-specific modules may preferably be preserved intact, and/or such that the cassette analysis and service method may preferably, but need not necessarily, remain certified for use with the aforesaid at least one of the cassette types.

According to an aspect of one preferred embodiment of the invention, the cassette analysis and service method may preferably, but need not necessarily, also include steps (h) and (i). Preferably in step (h), an unsupported cassette type may preferably, but need not necessarily, be removed from the cassette types supported by the cassette analysis and service method. Preferably in step (i), the service module may preferably, but need not necessarily, determine, preferably from the configuration components, that the unsupported cassette type may be absent from the cassette types supported by the cassette analysis and service method. Steps (h) and (i) may preferably, but need not necessarily, be such that the integrity of each of the cassette-specific modules may preferably be preserved intact, and/or such that the cassette analysis and service method may preferably, but need not necessarily, remain certified for use with the aforesaid at least one of the cassette types.

According to the invention, there is also disclosed a computer readable medium for use by a processing device. The computer readable medium is for use with cassettes of a plurality of supported cassette types. The supported cassette types include lateral flow and/or immuno-chromatographic strip types. The computer readable medium is also for use with a client module running locally on the processing device and/or remotely over a network. The computer readable medium is encoded with executable instructions to, when executed, encode one or more processors of the processing device to automatically perform steps (a) through (d). In step (a), the processors communicate with the client module. In step (b), the processors determine, from one or more configuration components, the supported cassette types and the configuration parameters for each of the supported cassette types. In step (c), the processors use one or more sets of pre-defined generic interfaces to communicate with cassette-specific modules. Each of the cassette-specific modules includes one or more cassette-specific algorithms specifically adapted for identification, analysis and/or processing of a predetermined one of the supported cassette types. In step (d), each of the cassette-specific algorithms uses a predetermined one or more tool sets. Each of the tool sets includes a set of one or more tools. In step (d), the predetermined one or more tool sets are used in identifying, analyzing and/or processing the predetermined one of the supported cassette types. In step (d), the cassette-specific algorithms of the cassette-specific modules use the tool sets to identify, analyze and/or process the cassettes of the supported cassette types. In step (c), the cassette-specific modules communicate results of the cassette-specific algorithms. In step (a), the results are communicated to the client module. As such, the processors automatically identify, analyze and/or process the cassettes of the supported cassette types. The processing device is certified for use with at least one of the supported cassette types when the processors are encoded with the executable instructions from the computer readable medium. When a new cassette type is added to the supported cassette types, the processors automatically perform the further steps (e) through (g). In step (e), a new one of the cassette-specific modules and a new one of the configuration components are received. In step (f), the processors determine, from the new one of the configuration components, the new cassette type as one of the supported cassette types and the configuration parameters. In step (g), the processors communicate with the new one of the cassette-specific modules using the aforesaid one or more sets of the pre-defined generic interfaces. According to the invention, steps (e) through (g) are such that an integrity of each other one of the cassette-specific modules is preserved intact, and such that the processing device remains certified for use with said at least one of the supported cassette types

Other advantages, features and characteristics of the present invention, as well as methods of operation and functions of the related elements of the device, system, method and computer readable medium will become more apparent upon consideration of the following detailed description and the appended claims with reference to the accompanying drawings, the latter of which are briefly described hereinbelow.

### BRIEF DESCRIPTION OF THE DRAWINGS

Novel features which are believed to be characteristic of the device, system, method and computer readable medium according to the present invention, as to their structure, organization, use, and method of operation, together with further objectives and advantages thereof, will be better understood from the following drawings in which presently preferred embodiments of the invention will now be illustrated by way of example. It is expressly understood, however, that the drawings are for the purpose of illustration and description only, and are not intended as a definition of the limits of the invention. In the accompanying drawings:

FIG. 1 is a schematic diagram of a cassette analysis and service system according to a preferred embodiment of the invention;

FIG. 2 is a schematic diagram of the cassette analysis and service system of FIG. 1, shown adding support for a new cassette (ICS_n+1);

FIG. 3 is a schematic diagram of the cassette analysis and service system of FIG. 1, shown adding new image processing functionality; and

FIG. 4 is a schematic diagram of a cassette analysis and service method according to a preferred embodiment of the invention, shown making use of a new tool set.

### DETAILED DESCRIPTION OF THE PREFERRED EMBODIMENTS

Cassette Analysis System/Structure Design

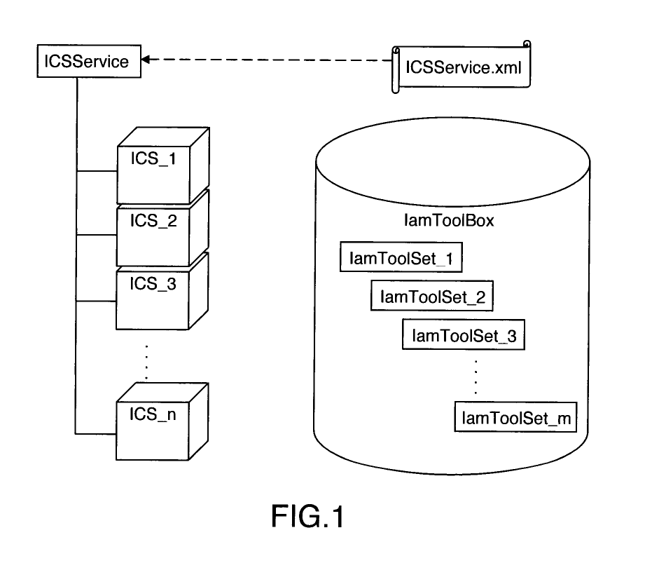

FIG. 1 shows a cassette analysis system structure according to a preferred embodiment of the invention which preferably includes: (a) an ICSService component, alternately referred to herein as a service module; (b) one or more ICSService.conf components, alternately referred to herein as configuration components; (c) one or more ICS_x components, alternately referred to herein as cassette-specific modules, e.g., an ICS_1 component, an ICS_2 component, an ICS_3 component, [ . . . ], and an ICS_n component; (d) an IamToolBox component, alternately referred to herein as a tool box module; and/or (e) one or more IamToolSet_x components, alternately referred to herein as tool sets, e.g., an IamToolSet_1 component, an IamToolSet_2 component, an IamToolSet_3 component, [ . . . ], and an IamToolSet_m component. [Aside—One or more “components” according to the invention may be alternately herein referred to as “modules”, “plug-ins” and/or “objects”.] One or more of these components may preferably, but need not necessarily, be main components of the cassette analysis system structure according to the invention.

a) ICSService

The ICSService component preferably takes requests from client applications and/or give analysis results. It preferably controls an analysis process in different modes according to a client application's request. Client applications preferably include applications running on the same device, modules within the same application, and/or remote applications communicating over a network.

b) ICSService.conf

The one or more ICSService.conf components preferably include one or more configuration files in one or more file formats. The configuration files may include configuration data. In a preferred embodiment of the invention, the configuration files preferably include (and the configuration data is preferably formatted as) an Extensible Markup Language (“XML”) file and/or a Javascript Object Notation (“JSON”) file, among others. The configuration files (and/or the configuration data) preferably include a list of supported and/or enabled cassette types and/or configuration parameters of each cassette type. The ICSService component preferably knows what cassettes types are to be supported, preferably by parsing the configuration data and/or one or more of the configuration files. The ICSService component also preferably acquires configurable parameters of each cassette type, preferably by the configuration data and/or one or more of the configuration files.

c) ICS_x

The ICS_x component preferably includes one or more cassette specific modules and/or libraries. It preferably holds un-configurable parameters of each cassette type, preferably such as, for example, a tool set that can be used to analyze this cassette, cassette identification parameters and/or templates, a location of the membrane, control and/or test line detection parameters, etc. It also preferably contains cassette specific logic, preferably such as, for example, an algorithm to interpret test lines and/or any necessary operations after identification. Every ICS_x module preferably follows one or more sets of pre-defined generic interfaces to the ICSService. For example, the interface set may include an identify interface, an isLabeled interface, a matchLabel interface, an analyze interface, and/or an interpret interface.

d) IamToolBox

The IamToolBox component preferably includes one or more collections of available tool sets.

e) IamToolSet_x

Every tool set preferably contains one or more tools. For example, the tools may be used to identify a cassette, to check the labeling (e.g., sticker, handwriting, barcode, etc), and/or to analyze a cassette. Every ICS_x module preferably has knowledge about which tool set preferably should be used to process itself.

Problem Solutions

The proposed approach preferably addresses the problem statement and/or overcomes one or more limitations of previous approaches, preferably as set out hereinbelow.

I. Adding Support of a New Cassette Type

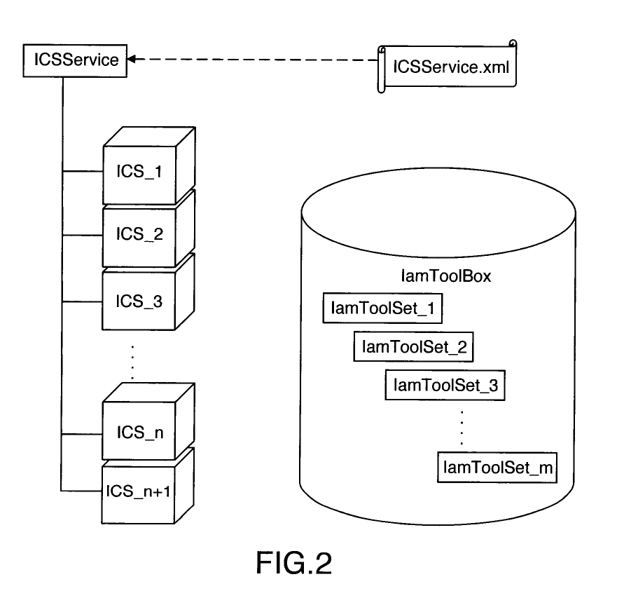

FIG. 2 shows adding support of a new cassette, ICS_n+1, according to a preferred embodiment of the invention. According to the invention, in adding support of a new cassette type, existing modules preferably need not be touched—and/or can remain undisturbed in an approved and/or certified state—except following changes and/or additions. Preferably, because no existing modules need be touched, they need not be re-certified.

One or more steps of adding support for a new cassette type according to a preferred embodiment of the invention are described in more detail as follows:
Push a new cassette module and/or plug-in, called ICS_n+1, to the target device—potentially remotely.
Push to the target device a new version and/or update of the ICSService.conf component, which preferably contains configuration parameters of the new cassette type.
   A complete new configuration may, according to some preferred embodiments of the invention, be pushed to the target device one or more times, or even each and every time (e.g., enable/disable settings and/or cassette specific configuration for ALL cassettes). In this case, for example, ICSService may validate the new configuration and replace it with its existing configuration data. And/or,
   Partial updates to the configuration alternately and/or in addition may, according to some preferred embodiments of the invention, be pushed to the target device one or more times, or even each and every time (e.g., enable/disable a specific cassette, and/or update configuration for one or more specific cassettes only). In this case, for example, the ICSService may maintain its existing configuration and only modify the parameters provided in the partial update. And/or,
Issue a command to the ICSService component, preferably telling it to parse the new configuration files and/or configuration data.

According to the invention, preferably by parsing the new configuration files and/or configuration data, the ICSService component preferably knows of the existence of the newly added ICS_n+1 module, and/or it preferably dynamically adds ICS_n+1 to its support list and/or starts to support it.

According to the invention, preferably because ICS_n+1 also follows the same set of interfaces, the ICSService component preferably identifies it and/or analyzes it, preferably using the existing way of making function calls and/or the existing logics.

II. Adding New Image Processing Functionality

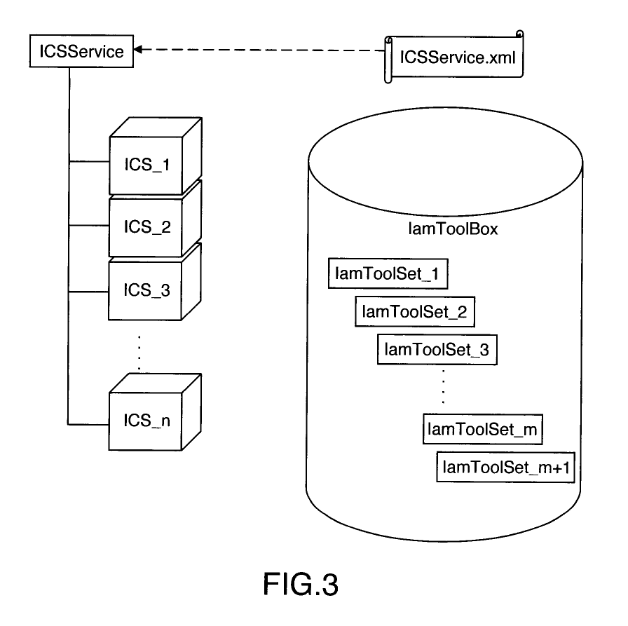

FIG. 3 shows adding new image processing functionality according to a preferred embodiment of the invention. According to the invention, in adding a new image processing functionality, existing modules preferably need not be touched—and/or can remain undisturbed in an approved and/or certified state—except following changes and/or additions. Preferably, because existing modules need not be touched, they need not be re-certified.

One or more steps of adding new image processing functionality according to a preferred embodiment of the invention are described in more detail as follows:
Push a new tool set, called IamToolSet_m+1, to the target device. And/or,
Modify one or more of the cassette modules, for example ICS_3, which will make use of the new tool set.

In this way, according to the invention, preferably only the modified cassette modules (e.g., ICS_3) will be modified to make use of the new tool set and/or, preferably, those cassette modules are the only ones which will need to be re-certified.

III. Making Use of a New Tool Set

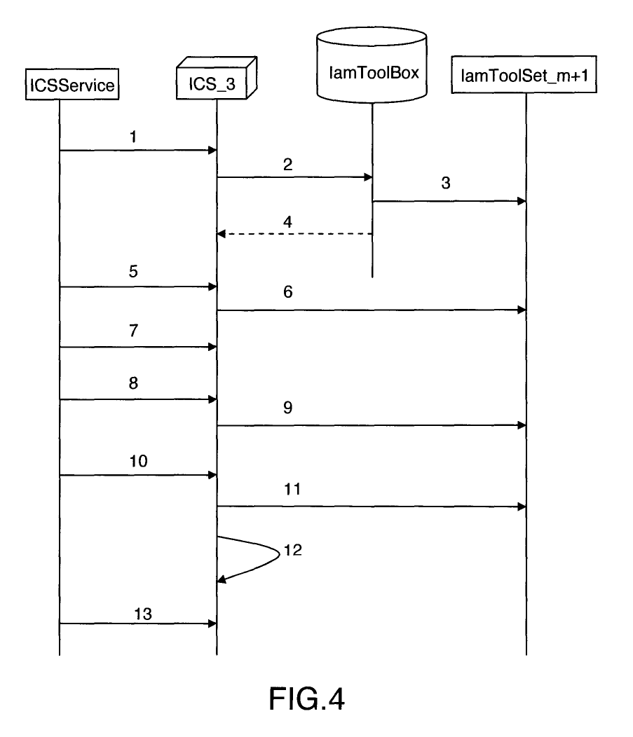

FIG. 4 shows a call sequence and/or making use of a new tool set according to a preferred embodiment of the invention. The call sequence may preferably, but need not necessarily, start from the top and/or proceed to the bottom of FIG. 4 according to one aspect of the invention.

The call sequence shows how one of the cassette modules (e.g., ICS_3) preferably makes use of a newly added tool set (e.g., IamToolSet_m+1) according to the invention. Continuing this example, with reference to FIG. 4 and the numeration therein, one or more steps of making use of the new tool set according to a preferred embodiment of the invention are described in more detail as follows:

In step 1 shown in FIG. 4, the ICSService component preferably constructs an ICS_3 component.

In step 2 shown in FIG. 4, according to configuration parameters in the ICS_3 component, the ICS_3 component preferably knows that the IamToolSet_m+1 component shall be used and/or preferably, therefore, asks for the IamToolSet_m+1 component from the IamToolBox component.

In step 3 shown in FIG. 4, preferably if the IamToolBox component does not currently have an IamToolSet_m+1 component constructed, it preferably constructs one.

In step 4 shown in FIG. 4, the IamToolBox component preferably gives the IamToolSet_m+1 component to the ICS_3 component.

In step 5 shown in FIG. 4, the ICSService component preferably makes an identification call to the ICS_3 component, preferably asking it to identify whether or not the cassette in the image is itself.

In step 6 shown in FIG. 4, the ICS_3 component makes an identification call to the IamToolSet_m+1 component which preferably processes the image and/or identifies the cassette.

In step 7 shown in FIG. 4, preferably if the identification process was successful, the ICSService component preferably makes a call to get one or more identification results.

In step 8 shown in FIG. 4, preferably if the cassette is successfully identified, the ICSService component preferably makes a call to check the label (e.g., sticker, handwriting, and/or barcode) on the cassette.

In step 9 shown in FIG. 4, the ICS_3 component preferably makes a call to the IamToolSet_m+1 component, preferably asking it to analyze the labeling area.

In step 10 shown in FIG. 4, preferably if the labeling is okay, the ICSService component preferably makes an analysis call to ICS_3 component, preferably asking it to perform a clinical diagnosis.

In step 11 shown in FIG. 4, the ICS_3 component makes a call to the IamToolSet_m+1 component, preferably asking it to analyze the concerning areas (e.g., buffer well, blood well, and/or membrane).

In step 12 shown in FIG. 4, the ICS_3 component interprets the analysis results from the IamToolSet_m+1 component and/or determines the clinical result. And/or,

In step 13 shown in FIG. 4, the ICSService component makes a call to the ICS_3 component, preferably to get a final interpretation result.

### CONCLUSION

The present invention is contemplated for use in association with a lateral flow/ICS service and/or cassette analysis device, system, method and/or computer readable medium, to afford increased functionality and/or advantageous utilities in association with same. The present invention, however, is not so limited.

Naturally, in view of the teachings and/or disclosures herein, persons having ordinary skill in the art may appreciate that alternate designs and/or embodiments of the invention may be possible (e.g., with substitution of one or more components, modules, objects, features, steps, algorithms, etc. for others, with alternate configurations of components, modules, objects, features, steps, algorithms, etc).

Features included in preferred and/or alternate embodiments of the invention may include one or more of the following: (a) most configurations may reside in the configuration files rather than, or in addition to, the ICS modules; (b) alternate structures for the configuration files; (c) more than one configuration file; and/or (d) the remote loading of one or more ICS modules as plug-ins. In having most configurations reside in the configuration files, it may be important to consider what can be changed, and potential risk issues which may be associated with what changes, by what type of user or by what type of over-the-air programming

Although some of the components, modules, objects, features, steps, algorithms, relations and/or configurations according to the invention are not specifically referenced in association with one another, they may be used, and/or adapted for use, in association therewith. All of the aforementioned, depicted and/or various components, modules, objects, structures, configurations, features, steps, algorithms, relationships, utilities and the like may be, but are not necessarily, incorporated into and/or achieved by the invention. Any one or more of the aforementioned components, modules, objects, structures, configurations, features, steps, algorithms, relationships, utilities and the like may be implemented in and/or by the invention, on their own, and/or without reference, regard or likewise implementation of any of the other aforementioned components, modules, objects, structures, configurations, features, steps, algorithms, relationships, utilities and the like, in various permutations and combinations, as will be readily apparent to those skilled in the art, without departing from the pith, marrow, and spirit of the disclosed invention.

This concludes the description of presently preferred embodiments of the invention. The foregoing description has been presented for the purpose of illustration and is not intended to be exhaustive or to limit the invention to the precise form disclosed. Other modifications, variations and alterations are possible in light of the above teaching and will be apparent to those skilled in the art, and may be used in the design and manufacture of other embodiments according to the present invention without departing from the spirit and scope of the invention. It is intended the scope of the invention be limited not by this description but only be the claims forming a part hereof.

What is claimed is:

1. A cassette analysis and service system used by a processing device, for use with cassettes of a plurality of cassette types supported by the cassette analysis and service system, with the cassette types including lateral flow and/or immuno-chromatographic strip types, and for use with a client module running locally on the processing device and/or remotely over a network, wherein the cassette analysis and service system comprises:
(a) a service module in communication with the client module;
(b) one or more configuration components comprising one or more lists of the cassette types supported by the cassette analysis and service system and configuration parameters for each of the cassette types; wherein the service module determines, from the configuration components, the cassette types supported by the cassette analysis and service system and the configuration parameters for each of the cassette types;
(c) a plurality of cassette-specific modules, each comprising one or more cassette-specific algorithms specifically adapted for identification, analysis and/or processing of a predetermined one of the cassette types; wherein the service module communicates with each of the cassette-specific modules using one or more sets of pre-defined generic interfaces;
(d) a plurality of tool sets, each comprising a set of one or more tools adapted for identification, analysis and/or processing of the cassette types; wherein each of the cassette-specific algorithms is specifically adapted to use a predetermined one or more of the tool sets in identifying, analyzing and/or processing the predetermined one of the cassette types;
wherein, in use: the client module communicates with the service module; the service module communicates with the cassette-specific modules; the cassette-specific algorithms of the cassette-specific modules use the tool sets to identify, analyze and/or process the cassettes of the cassette types supported by the cassette analysis and service system; the cassette-specific modules communicate results of the cassette-specific algorithms to the service module; and the service module communicates said results to the client module; such that the processing device identifies, analyzes and/or processes the cassettes of the cassette types supported by the cassette analysis and service system; and
wherein the cassette analysis and service system is certified for use with at least one of the cassette types and wherein, when a new cassette type is added to the cassette types supported by the cassette analysis and service system: a new one of the cassette-specific modules and a new one of the configuration components are received by the processing device; the service module determines, from the new one of the configuration components, the new cassette type as supported by the cassette analysis and service system and the configuration parameters for the new cassette type; the service module communicates with the new one of the cassette-specific modules using said one or more sets of the pre-defined generic interfaces; and an integrity of each other one of the cassette-specific modules is preserved intact, such that the cassette analysis and service system remains certified for use with said at least one of the cassette types.

2. The cassette analysis and service system according to claim 1 adapted for use with images of the cassettes; and wherein, in use: the cassette-specific algorithms of the cassette-specific modules use the tool sets to identify, analyze and/or process the images of the cassettes of the cassette types supported by the cassette analysis and service system.

3. The cassette analysis and service system according to one of claims 1 and 2, wherein the service module takes requests from the client module, and controls an analysis process in different modes according to the requests from the client module.

4. The cassette analysis and service system according to any one of claims 1 to 3, wherein the configuration components comprise configuration data formatted in one or more Extensible Markup Language (“XML”) file formats and/or Javascript Object Notation (“JSON”) file formats.

5. The cassette analysis and service system according to claim 4, wherein the service module parses the configuration data to determine the cassette types supported by the cassette analysis and service system and the configuration parameters for each of the cassette types.

6. The cassette analysis and service system according to any one of claims 1 to 5, wherein the configuration parameters comprise incubation timer value configuration parameters, expiration timer value configuration parameters, and/or test line value cut-off value configuration parameters for one or more of the cassette types.

7. The cassette analysis and service system according to claim 6, wherein the cassette-specific algorithms are specifically adapted for identification, analysis and/or processing using one or more incubation timer value configurations, expiration timer value configurations, and/or test line value cut-off value configurations.

8. The cassette analysis and service system according to any one of claims 1 to 7, wherein the cassette-specific modules comprise un-configurable parameters and/or templates specifically adapted for identification, analysis and/or processing of the predetermined one of the cassette types.

9. The cassette analysis and service system according to any one of claims 1 to 8, wherein the cassette-specific algorithms of each of the cassette-specific modules are specifically adapted for identification, analysis and/or processing of a membrane location, a control line, and/or a test line of the predetermined one of the cassette types.

10. The cassette analysis and service system according to any one of claims 1 to 9, wherein the sets of pre-defined generic interfaces comprise: an identity interface for communicating an identity of the predetermined one of the cassette types; one or more label interfaces for communicating when the predetermined one of the cassette types is labeled and/or when a label is matched on the predetermined one of the cassette types; and/or one or more analysis and/or interpretation interfaces.

11. The cassette analysis and service system according to any one of claims 1 to 10, wherein each of the cassette-specific algorithms employs a call sequence to make use of the predetermined one or more of the tool sets.

12. The cassette analysis and service system according to any one of claims 1 to 11, wherein the tools are used to identify the cassettes, to check labeling on the cassettes, and/or to analyze the cassettes.

13. The cassette analysis and service system according to any one of claims 1 to 12, further comprising a tool box module comprising one or more collections of the tool sets, wherein the tool box module constructs the predetermined one or more of the tool sets when called for by the cassette-specific algorithms.

14. The cassette analysis and service system according to any one of claims 1 to 13 wherein, when a new tool is added to the tools adapted for identification, analysis and/or processing of the cassettes: a new one of the cassette-specific modules and a new one of the tool sets comprising the new tool are received by the processing device; the cassette-specific algorithms of the new one of the cassette-specific modules are specifically adapted to use the new one of the tool sets in identifying, analyzing and/or processing the predetermined one of the cassette types; and the integrity of said each other one of the cassette-specific modules is preserved intact.

15. The cassette analysis and service analysis system according to any one of claims 1 to 14 wherein, when an unsupported cassette type is removed from the lists of the cassette types supported by the cassette analysis and service system, the service module determines from the configuration components that the unsupported cassette type is absent from the lists of the cassette types supported by the cassette analysis and service system; and the integrity of each of the cassette-specific modules is preserved intact.

16. A cassette analysis and service device, for use with cassettes of a plurality of supported cassette types, with the supported cassette types including lateral flow and/or immuno-chromatographic strip types, and for use with a client module running locally on the cassette analysis and service device and/or remotely over a network, wherein the cassette analysis and service device comprises:
(a) a service module in communication with the client module;
(b) one or more configuration components comprising one or more lists of the supported cassette types and configuration parameters for each of the supported cassette types; wherein the service module determines, from the configuration components, the supported cassette types and the configuration parameters for each of the supported cassette types;
(c) a plurality of cassette-specific modules, each comprising one or more cassette-specific algorithms specifically adapted for identification, analysis and/or processing of a predetermined one of the supported cassette types; wherein the service module communicates with each of the cassette-specific modules using one or more sets of pre-defined generic interfaces;
(d) a plurality of tool sets, each comprising a set of one or more tools adapted for identification, analysis and/or processing of the supported cassette types; wherein each of the cassette-specific algorithms is specifically adapted to use a predetermined one or more of the tool sets in identifying, analyzing and/or processing the predetermined one of the supported cassette types;
wherein, in use: the client module communicates with the service module; the service module communicates with the cassette-specific modules; the cassette-specific algorithms of the cassette-specific modules use the tool sets to identify, analyze and/or process the cassettes of the supported cassette types; the cassette-specific modules communicate results of the cassette-specific algorithms to the service module; and the service module communicates said results to the client module; such that the cassette analysis and service device identifies, analyzes and/or processes the cassettes of the supported cassette types; and
wherein the cassette analysis and service device is certified for use with at least one of the supported cassette types and wherein, when a new cassette type is added to the supported cassette types: a new one of the cassette-specific modules and a new one of the configuration components are received by the cassette analysis and service device; the service module determines, from the new one of the configuration components, the new cassette type as one of the supported cassette types and the configuration parameters for the new cassette type; the service module communicates with the new one of the cassette-specific modules using said one or more sets of the pre-defined generic interfaces; and an integrity of each other one of the cassette-specific modules is preserved intact, such that the cassette analysis and service device remains certified for use with said at least one of the supported cassette types.

17. A cassette analysis and service method for use with cassettes of a plurality of cassette types supported by the cassette analysis and service method, with the cassette types including lateral flow and/or immuno-chromatographic strip types, wherein the cassette analysis and service method comprises the steps of:
(a) a service module communicating with a client module running locally and/or remotely over a network;
(b) the service module determining, from one or more configuration components, the cassette types supported by the cassette analysis and service method and the configuration parameters for each of the cassette types;
(c) using one or more sets of pre-defined generic interfaces, the service module communicates with cassette-specific modules, each comprising one or more cassette-specific algorithms specifically adapted for identification, analysis and/or processing of a predetermined one of the cassette types;
(d) each of the cassette-specific algorithms uses a predetermined one or more tool sets, with each of the tool sets comprising a set of one or more tools, in identifying, analyzing and/or processing the predetermined one of the cassette types;
wherein: in step (d), the cassette-specific algorithms of the cassette-specific modules use the tool sets to identify, analyze and/or process the cassettes of the cassette types supported by the cassette analysis and service method; in step (c), the cassette-specific modules communicate results of the cassette-specific algorithms to the service module; and in step (a), the service module communicates said results to the client module; such that the cassette analysis and service method identifies, analyzes and/or processes the cassettes of the cassette types supported by the cassette analysis and service method; and
wherein the cassette analysis and service method is certified for use with at least one of the cassette types and wherein, when a new cassette type is added to the cassette types supported by the cassette analysis and service system, the cassette analysis and service method further comprises the steps of: (e) receiving a new one of the cassette-specific modules and a new one of the configuration components; (f) the service module determining, from the new one of the configuration components, the new cassette type as supported by the cassette analysis and service system and the configuration parameters for the new cassette type; (g) the service module communicating with the new one of the cassette-specific modules using said one or more sets of the pre-defined generic interfaces; all such that an integrity of each other one of the cassette-specific modules is preserved intact, and such that the cassette analysis and service method remains certified for use with said at least one of the cassette types.

18. The cassette analysis and service method according to claim 17 adapted for use with images of the cassettes; and wherein, in step (d), the cassette-specific algorithms of the cassette-specific modules use the tool sets to identify, analyze and/or process the images of the cassettes of the cassette types supported by the cassette analysis and service system.

19. The cassette analysis and service method according to one of claims 17 and 18 wherein, in step (a), the service module takes requests from the client module; and wherein the service module controls an analysis process in different modes according to the requests from the client module.

20. The cassette analysis and service method according to any one of claims 17 to 19, wherein the configuration components comprise configuration data; and wherein, in step (b), the service module parses the configuration data to determine the cassette types supported by the cassette analysis and service method and the configuration parameters for each of the cassette types.

21. The cassette analysis and service method according to any one of claims 17 to 20 wherein, in step (d), the cassette-specific algorithms identify, analyze and/or process the predetermined one of the cassette types using one or more incubation timer value configurations, expiration timer value configurations, and/or test line value cut-off value configurations.

22. The cassette analysis and service method according to any one of claims 17 to 21 wherein, in step (d), the cassette-specific algorithms of each of the cassette-specific modules identify, analyze and/or process a membrane location, a control line, and/or a test line of the predetermined one of the cassette types.

23. The cassette analysis and service method according to any one of claims 17 to 22 wherein, in step (c), the sets of pre-defined generic interfaces comprise: an identity interface for communicating an identity of the predetermined one of the cassette types; one or more label interfaces for communicating when the predetermined one of the cassette types is labeled and/or when a label is matched on the predetermined one of the cassette types; and/or one or more analysis and/or interpretation interfaces.

24. The cassette analysis and service method according to any one of claims 17 to 23 wherein, in step (d), each of the cassette-specific algorithms employs a call sequence to make use of the predetermined one or more tool sets.

25. The cassette analysis and service method according to any one of claims 17 to 24 wherein, in step (d), the tools are used to identify the cassettes, to check labeling on the cassettes, and/or to analyze the cassettes.

26. The cassette analysis and service method according to any one of claims 17 to 25, further comprising the step of: (h) using a tool box module, comprising one or more collections of the tool sets, to construct the predetermined one or more tool sets when called for by the cassette-specific algorithms.

27. The cassette analysis and service method according to any one of claims 17 to 25 further comprising, when a new tool is added to the tools adapted for identification, analysis and/or processing of the cassettes, the steps of: (h) receiving a new one of the cassette-specific modules and a new one of the tool sets comprising the new tool; and (i) the cassette-specific algorithms of the new one of the cassette-specific modules use the new one of the tool sets in identifying, analyzing and/or processing the predetermined one of the cassette types; such that the integrity of said each other one of the cassette-specific modules is preserved intact.

28. The cassette analysis and service method according to any one of claims 17 to 25, further comprising the steps of: (h) removing an unsupported cassette type from the cassette types supported by the cassette analysis and service method; and (i) the service module determining, from the configuration components, that the unsupported cassette type is absent from the cassette types supported by the cassette analysis and service method; such that the integrity of each of the cassette-specific modules is preserved intact.

29. A computer readable medium for use by a processing device, for use with cassettes of a plurality of supported cassette types, with the supported cassette types including lateral flow and/or immuno-chromatographic strip types, and for use with a client module running locally on the processing device and/or remotely over a network, the computer readable medium encoded with executable instructions to, when executed, encode one or more processors of the processing device to automatically perform the steps of:
(a) communicating with the client module;
(b) determining, from one or more configuration components, the supported cassette types and the configuration parameters for each of the supported cassette types;
(c) using one or more sets of pre-defined generic interfaces to communicate with cassette-specific modules, each comprising one or more cassette-specific algorithms specifically adapted for identification, analysis and/or processing of a predetermined one of the supported cassette types;
(d) each of the cassette-specific algorithms uses a predetermined one or more tool sets, with each of the tool sets comprising a set of one or more tools, in identifying, analyzing and/or processing the predetermined one of the supported cassette types;
wherein: in step (d), the cassette-specific algorithms of the cassette-specific modules use the tool sets to identify, analyze and/or process the cassettes of the supported cassette types; in step (c), the cassette-specific modules communicate results of the cassette-specific algorithms; and in step (a), said results are communicated to the client module; such that the processors automatically identify, analyze and/or process the cassettes of the supported cassette types; and
wherein the processing device is certified for use with at least one of the supported cassette types when the processors are encoded with the executable instructions from the computer readable medium and wherein, when a new cassette type is added to the supported cassette types, the processors automatically perform the further steps of: (e) receiving a new one of the cassette-specific modules and a new one of the configuration components; (f) determining, from the new one of the configuration components, the new cassette type as one of the supported cassette types and the configuration parameters; (g) communicating with the new one of the cassette-specific modules using said one or more sets of the pre-defined generic interfaces; all such that an integrity of each other one of the cassette-specific modules is preserved intact, and such that the processing device remains certified for use with said at least one of the supported cassette types.
